(19) United States
(12) Patent Application Publication
(10) Pub. No.: US 2006/0169748 A1
(43) Pub. Date: Aug. 3, 2006

(54) Friction stir welding method

(76) Inventors: Masakuni Ezumi, Hofu-shi (JP); Norihisa Okada, Hikari-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/213,745

(22) Filed: Aug. 30, 2005

(30) Foreign Application Priority Data
Feb. 1, 2005 (JP) 2005-024696

(51) Int. Cl. B23K 20/12; B23K 31/02

(52) U.S. Cl. 228/112.1

(57) ABSTRACT

The invention provides a friction stir welding method with less weld defects upon welding a butted portion between a first member and a second member. A first member 10 is butted against a second member 20, and then a round-bar buildup member 30 is pressed against the upper surface of the butted portion and rotated to weld a buildup bead 35 thereon. The buildup bead corresponds to a projection of the prior art friction stir welding method. Next, a pin 51 of the rotary tool 50 is inserted to the butted portion to perform friction stir welding. According to this method, the buildup bead 35 corresponds to a projection and fills the space formed to the butted portion, so a good weld joint is formed and the generation of defects is suppressed.

The present application is based on and claims priority of Japanese patent application No. 2005-24696 filed on Feb. 1, 2005, the entire contents of which are hereby incorporated by reference.

### BACKGROUND OF THE INVENTION

1. Field of the Invention

The present invention relates to a friction stir welding method for welding two members. More specifically, it relates to a friction stir welding method for welding two members butted against each other.

2. Description of the Related Art

A friction stir welding method is disclosed in Japanese Patent No. 03014654 (U.S. Pat. No. 6,581,819) (patent document 1). As disclosed in patent document 1, a friction stir welding method relates to inserting a rotary tool to a butted portion between two members, rotating the rotary tool to soften the members and to perform solid-phase welding of the members.

In general, a friction stir welding method is performed by butting together panel members having the same thickness and welding the butted portion thereof.

Furthermore, as shown in patent document 1, it is not possible to obtain a good joint if a space exists at the butted portion between the two members, so extruded shape members having projections formed to the butted portions are butted against one another, and friction stir welding is performed so that the metal material constituting the projection is filled in the space formed at the butted portion. After performing friction stir welding, the unnecessary projection is cut and removed.

Upon performing friction stir welding of two members having different thicknesses, as illustrated in FIG. 4 of Japanese Patent Application Laid-Open Publication No. 2003-062680 (U.S. Pat. No. 6,779,705) (patent document 2), the members are butted against each other, and deposit welding is performed to the surface of the member having a smaller thickness before the members are subjected to friction stir welding. Thereafter, if necessary, the unnecessary portion is cut and removed.

However, in this case, since deposit welding is performed manually, it requires much work. Further, black marks are adhered to the surface of the members during the welding process, which deteriorates the appearance, and the weld heat may deform the panel (members).

Moreover, as disclosed in patent document 2, the member having a greater panel thickness may have a protruded block at the butted portion for receiving the thinner member. In this arrangement, a defect is likely to occur in the friction stir weld bead. It is possible to form a friction stir weld joint eliminating such defects, but since the conditional range of such friction stir welding is narrow, it is extremely difficult to perform such welding.

In this case, the thinner panel is positioned to overlap with the protruded block on the thicker panel, but if there is a space formed between the upper surface of the protruded block and the lower surface of the thinner panel, a defect is likely to occur in the friction stir weld bead. In order to prevent the occurrence of defects, it is important to have the upper surface of the panel having the protruded block contact the lower surface of the panel being placed thereon (the thinner panel) so that no space is formed therebetween.

### SUMMARY OF THE INVENTION

The first object of the present invention is to provide a good friction stir weld joint upon welding a butted portion between two members.

Further, the second object of the present invention is to create a good friction stir weld joint upon welding a butted portion between two members having different thicknesses.

The first object of the present invention is achieved by a friction stir welding method comprising butting a first member against a second member, and welding a buildup bead to at least one of said first or second member having a smaller panel thickness in an area near the butted portion by rotating a buildup member in contact with the first or second member and relatively moving the buildup member along the butted portion.

Further, the second object of the present invention, in which friction stir welding is performed to weld two members having different thicknesses, is achieved by the friction stir welding method mentioned above in which the second member has a protruded block for placing the first member at a side of the butted portion; the thickness from the protruded block to an upper surface of the second member is greater than the thickness of the first member; an end of the second member is butted against the first member with the second member overlapped with the protruded block; the buildup member is in contact with and rotated on the upper surface of the first member close to the second member to thereby weld the buildup bead; and the rotary tool is inserted from the side having the buildup bead to perform friction stir welding of the second member and the first member.

In this description, the terms “thin panel” and “thick panel” refer to the state in which the panels at the butted portion have upper surfaces positioned at different heights. The panel having its upper surface positioned higher is called the thick panel, and the panel having is upper surface positioned lower is called the thin panel. Further, the term “panel” includes an extruded shape member.

### BRIEF DESCRIPTION OF THE DRAWINGS

FIG. 1 is a perspective view of embodiment 1 of the present invention in which a buildup bead is welded;

FIG. 2 is an A-A cross-section of FIG. 1;

FIG. 3 is a B-B cross-section of FIG. 1;

FIG. 4 is a drawing of embodiment 1 of the present invention, in which friction stir welding is performed on the buildup bead;

FIG. 5 is a C-C cross-section of FIG. 4;

FIG. 6 is a D-D cross-section of FIG. 4;

FIGS. 7(A)-(D) are cross-sectional views of embodiment 2 of the present invention, in which the steps for friction stir welding are illustrated; and

FIG. 8 is a vertical cross-sectional view of embodiment 3 of the present invention.

### DETAILED DESCRIPTION OF THE PREFERRED EMBODIMENTS

Now, the preferred embodiments for carrying out the present invention will be described.

### Embodiment 1

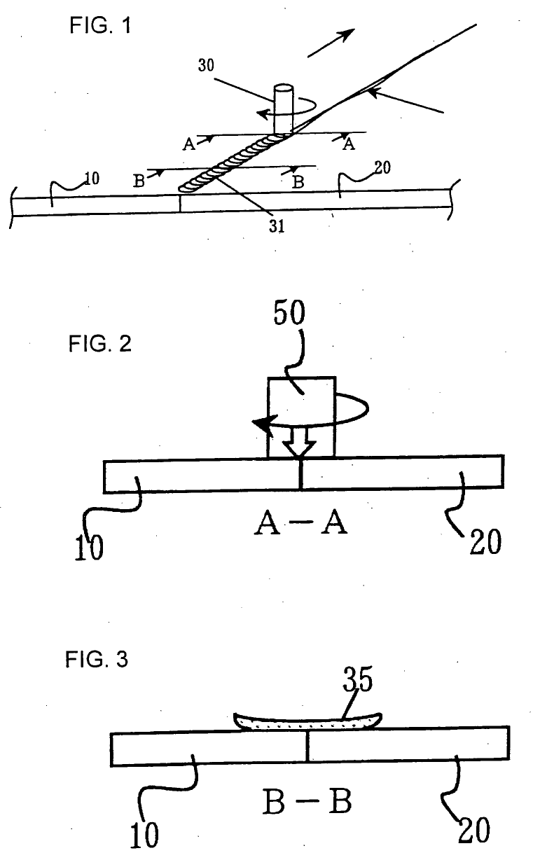

Now, the present invention will be described with reference to FIGS. 1 through 3. In FIG. 1, panels 10 and 20 are butted against each other. The material of the panels 10 and 20 is aluminum alloy. The back sides of the panels 10 and 20 are placed on a base (not shown).

In this state, at first, a buildup member 30 is pressed on the upper surface of the butted portion from above, and the buildup member is rotated and relatively moved along the butted portion. The buildup member 30 is a round bar which is made of aluminum alloy material similar to panels 10 and 20. Thereby, a buildup bead 35 is welded to the upper surface of the butted portion along with the movement of the buildup member 30.

By the buildup member 30 being transferred as the buildup bead 35, the buildup member 30 becomes short, and at an appropriate timing, the rotation and movement of the buildup member is stopped, and the consumed buildup member is replaced with a new buildup member having a predetermined length.

The buildup bead 35 is welded onto the upper surface of the panel 10. The thickness of the buildup bead 35 is increased along with the rotation of the buildup member 30. The buildup bead 35 is welded onto the upper surface of the panels 10 and 20.

The thickness of the buildup bead 35 should approximately be 1 mm. Preferably, the bead should be thicker than 0.5 mm. The buildup bead 35 corresponds to the projection according to the prior art. The buildup bead not only corresponds to the prior art projection, but it contributes to reducing the gap, if any, between the panels 10 and 20 by entering the gap. Thus, defects are not likely to occur at the friction stir weld joint.

As described in patent document 1, if there is a gap between the butted surfaces of two members, a defect may be generated at the friction stir weld joint, but since according to the present invention, the metal material of the friction weld bead 35 provides the material for filling the gap, so the generation of detects at the joint caused by the gap can be suppressed. Furthermore, if there is no fiction weld bead 35, a boundary portion 53 between a large-diameter portion of a rotary tool 50 and a center pin 53 disposed along a center axis thereof comes into contact directly with the panels 10 and 20, so that a recessed groove is formed by the boundary portion 53 to the panels 10 and 20, by which the thickness of the panels is substantially reduced, but since according to the present invention the boundary portion 53 contacts the friction weld bead, a recessed groove will not be generated to the panels, and the friction stir weld joint will have a superior appearance.

Moreover, since the friction stir weld bead 35 corresponding to the projection is formed after butting together the panels, rolled metal panels can be used instead of extruded shape members for the panels 10 and 20, so that friction stir welding can be applied more widely. Furthermore, since the friction weld bead 35 is formed to both panels 10 and 20 being butted against each other via friction welding, the weld bead 35 can be welded onto both panels by a single friction weld.

The buildup member 30 is pressed downward with predetermined pressure together with an electric motor for rotating the buildup member 30. Furthermore, the buildup member 30 and the electric motor are moved at predetermined speed with respect to the butted friction portion. A frictional heat occurs by the friction, and the metal of the friction member 30 is welded onto members 10 and 20. The amount of weld (thickness) is determined by the frictional heat.

The method for rotating and moving a buildup member 30 in the form of a round bar in contact with the surface of the metal of the counterpart member, and welding the metal of the metal bar to the counterpart metal panel by the contact heat caused by rotation is known, as disclosed in non-patent document 1.

The method for friction-welding a buildup member to a metal of the counterpart member so as to reform the surface thereof is disclosed in “Section 3: Friction Buildup” of Japan Welding Society Journal 2004 Vol. 6, p. 36-p. 40 “Surface Reforming through application of Friction Stir Welding” (non-patent document 1).

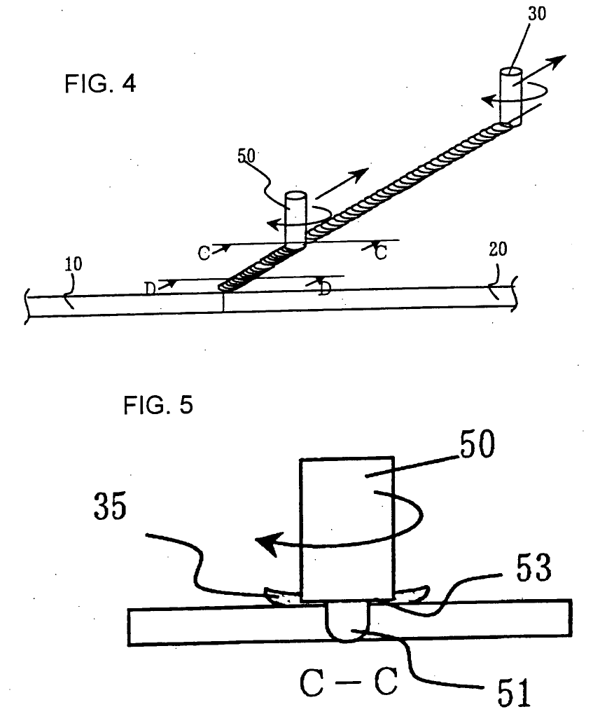

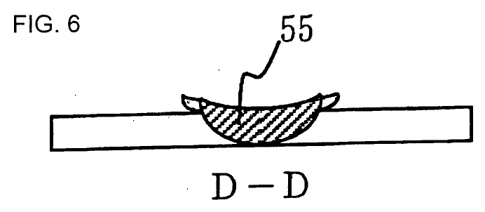

Next, as shown in FIGS. 4 through 6, a center pin 51 of the rotary tool 50 is inserted from the upper portion of the buildup bead 35 so as to join members 10 and 20 via friction stir welding. During friction stir welding, a bottom surface 53 of a large-diameter portion at the upper portion of the center pin 51 of the rotary tool is in contact with the buildup bead 35.

The outer diameter size of the buildup member 30 of FIG. 1 is 20 mm, and a weld bead 35 as illustrated in FIG. 3 having a width (width in the direction orthogonal to the direction of movement of the buildup member 30) somewhat greater (a few millimeters over 20 mm) than the diameter of the buildup member 30 is formed. The diameter of the large-diameter portion of the friction stir welding rotary tool 50 entering the buildup bead is 15 mm. Since the diameter of the large-diameter portion is smaller than the width of the weld bead 35 corresponding to the projection of the prior art, the weld bead 35 corresponds to the projection.

Next, if necessary (such as when the upper surface is used as the outer face of a device, or when a smooth surface is required), a friction stir bead 55 is cut and removed from the surface of the members 10 and 20.

According to this embodiment, the buildup bead 35 corresponds to the projection of the prior art method, and thus, it contributes to reducing the occurrence of defects when friction stir welding members 10 and 20.

Since according to the prior art, a projection had to be formed to the members, so the members to be welded had to be formed via extrusion, but according to the present invention, a rolled panel can be used as the panels 10 and 20.

The remaining buildup bead is removed by cutting, but since the buildup bead is thin, the cutting thereof is easy.

When the bead 35 is welded using the buildup member 30, the thickness of the bead 35 is not constant when the buildup member 30 is positioned perpendicularly with respect to the members 10 and 20, but if the buildup member 30 is tilted when contacting the members 10 and 20, a bead 35 having a constant thickness 35 can be formed. The direction of tilt should be the same as the direction of tilt of the rotary tool 50. That is, the leading end of the buildup member 30 (the lower end in FIG. 1) is positioned frontward in the direction of movement than the opposite end (upper end) during movement (in other words, the opposite end is positioned rearward than the leading end) The tilting angle is approximately 2 degrees.

As illustrated in FIG. 3, the buildup member 30 is used to form the buildup bead 35, and thereafter, the rotary tool 50 is inserted rearward in the direction of movement of the buildup member 30 to perform friction stir welding and form a friction stir weld bead 55.

The positional relationship of the buildup member 30 and the rotary tool 50 may be set so that friction stir welding is performed before the buildup bead 35 is cooled down to room temperature. Of course, it is possible to perform friction stir welding after the buildup bead is cooled down to room temperature.

According to the above embodiment, the buildup member 30 is moved to weld the buildup bead 35, but it is possible to move the members 10 and 20 with respect to the buildup member 30.

Moreover, it is possible to move the rotary tool 50 with respect to the panels 10 and 20, or to move the panels 10 and 20 with respect to the rotary tool 50.

According to the present embodiment, the welding of the buildup member 30 and the friction stir welding are performed at the same time, but the two processes can be performed separately.

### Embodiment 2

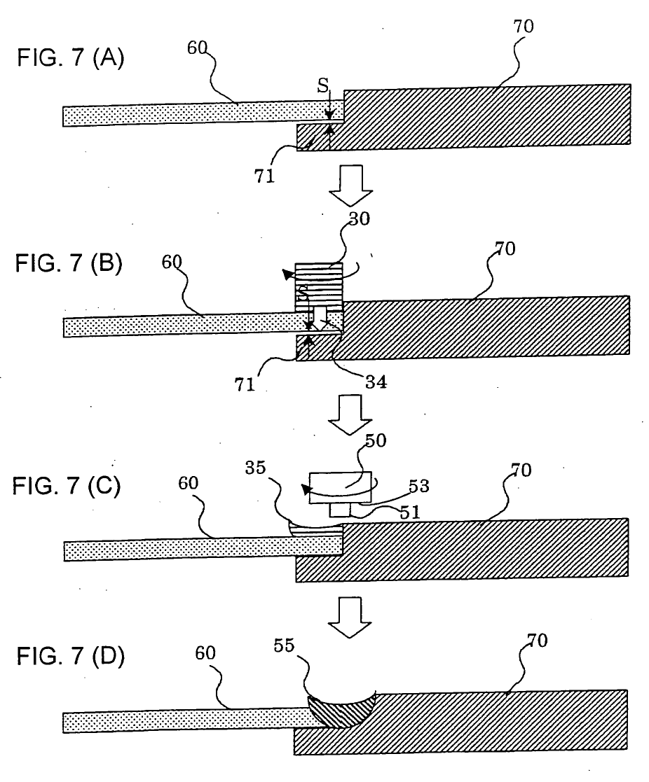

Embodiment 2 will now be described with reference to FIG. 7. Friction stir welding is carried out in the order of (A), (B), (C) and (D) of FIG. 7. Member 70 is an extruded shape member having a protruded block 71 for placing a member 60. The member 60 can also be an extruded shape member. The member 60 is placed on the protruded block 71 of the member 70, and thus the members 60 and 70 are butted against each other. The upper surface of the member 70 near the butted portion is higher than the upper surface of the member 60. The plate thickness of the member 60 is thinner than the plate thickness of the member 70. The member 70 is placed on a base (not shown).

After assembling the members as described above, at first, a buildup member 30 is used to bond a buildup bead 35 to the upper surface of the member 60. Thus, a buildup bead 35 is welded to the upper surface of the member 60. The buildup bead 35 is welded to the upper surface of the member 60 and the side end of the member 70 butted to the member 60. Since the buildup member 30 presses down the member 60 upon bonding the buildup bead 35, the space S between the protruded block 75 and the member 60 mounted thereon, if any, can be eliminated. Reference number 34 denotes a pressing force.

Next, the butted portion between the members 60 and 70 is friction stir welded via a rotary tool 50. Friction stir welding is performed with the bottom surface 53 of the large-diameter portion 52 of the rotary tool 50 inserted to the buildup bead 35. The rotational center of the rotary tool 50 is positioned at the butted portion between members 60 and 70. Since there is no space S formed between the bottom surface of the member 60 and the upper surface of the protruded block at this time, the two members can be welded well.

The portion of the friction stir bead 55 projected from the upper surfaces of the members 60 and 70 formed during friction stir welding is cut and removed.

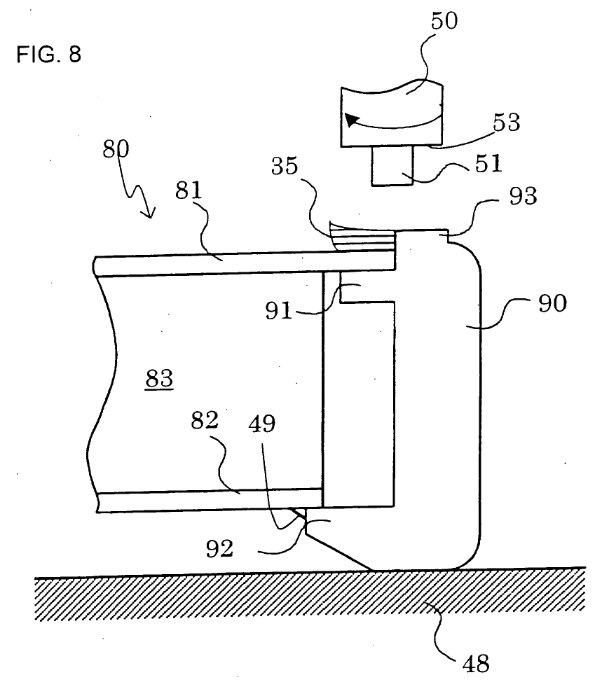

The above embodiment relates to an example in which the members 60 and 70 are panel members, but they can be hollow shape members. This example is described with reference to FIG. 8. FIG. 8 illustrates an entrance of a railway car. Member 80 is a hollow shape member constituting a side frame forming the side wall of the railway car. Reference number 90 denotes a frame member for an entrance formed to the side frame. Member 90 is not technically hollow since it has an open side surface (in other words, the protruded blocks 91 and 92 are not welded, so there is no hollow portion), but here it is referred to as a hollow shape member. The direction of extrusion of the extruded member 80 is in the left-right direction of the drawing. The direction of extrusion of the member 90 is in the direction orthogonal to the sheet surface of FIG. 2.

The right end side in the direction of extrusion of an upper face plate 81 of the member 80 overlaps with the upper surface of the protruded block 91 of the member 90. The upper and lower face plates 81 and 82 are joined via connecting plates 83. The three members are formed integrally from extruded shape members. The right end portion in the direction of extrusion of the lower face plate 82 and the connecting plate 83 of the member 80 is retreated in the left direction than the right end of the upper face plate 81. The hollow shape member constituting member 80 is cut and processed in such manner.

The upper face plate 81 of the member 80 overlaps with the upper surface of the protruded block 91. The lower face plate 82 of the member 80 is placed on the protruded block 92 at the lower surface of the member 90 (the protruded block 92 and the face plate 82 are overlapped). A projection 93 is provided to protrude upward from the member 90 along the upper face plate 81. The upper surface of the projection 93 is positioned higher than the upper surface of the face plate 81.

The members 80 and 90 are assembled as illustrated in FIG. 8, and fillet welding 49 is performed to the protruded block 92 and the face plate 82.

Next, the members are placed on a base 48 with the face plate 81 and the projection 93 facing upward, and then a buildup bead 35 is welded to the face plate 81 using a buildup member 30.

Thereafter, the butted portion between the face plate 81 and the member 90 is subjected to friction stir welding using a rotary tool 50.

Then, after performing friction stir welding, the upper surface of the friction stir weld joint and the projection 93 are cut and removed from the face plate 81 (in other words, the portion of the buildup weld bead 35, the friction stir weld joint and the projection 93 placed above the upper surface of the face plate are removed).

In this manner, the present embodiment (FIG. 8) is similar to the embodiment (second embodiment) of FIG. 7.

The embodiments described above related to friction stir welding the butted portions between two butted members, but it can be applied not only to butt joints but to friction stir welding of the overlapped portions of two members (panels). That is, by welding a buildup bead onto the surface of the member on the upper side (the side from which the friction stir welding tool is inserted) and performing friction stir welding of the portion using the rotary tool, the bottom surface of the rotary tool will be inside the buildup bead during welding, so that the recessed groove formed by the bottom surface of the rotary tool coming into contact with the surface of the object member will be formed on the buildup bead, which will otherwise be formed on the object member if there is no buildup bead, and such recessed groove can be removed easily by cutting off the remaining buildup bead after completing the friction stir welding.

What is claimed is:

1. A friction stir welding method comprising:
butting a first member against a second member;
welding a buildup bead to at least one of said first or second member having a smaller panel thickness in an area near the butted portion; and
performing friction stir welding by inserting a rotary tool from a side having the buildup bead into the buildup bead and the butted portion.

2. A friction stir welding method comprising:
butting a first member against a second member;
welding a buildup bead to at least one of said first or second member having a smaller panel thickness in an area near the butted portion by rotating a buildup member in contact with the first or second member and relatively moving the buildup member along the butted portion; and
performing friction stir welding by inserting a rotary tool from a side having the buildup bead into the buildup bead, the first member and the second member.

3. The friction stir welding method according to claim 2, wherein
the welding of the buildup bead by the buildup member is performed to weld the bead simultaneously to both the first panel member and the second panel member at the butted portion.

4. The friction stir welding method according to claim 2, wherein
the buildup member is cylindrical, and an outer diameter thereof is greater than an outer diameter of a large-diameter portion of the rotary tool.

5. The friction stir welding method according to claim 2, wherein
a width of the buildup bead formed by the buildup member (width orthogonal to the butted direction) is greater than a diameter of the large-diameter portion of the rotary tool.

6. The friction stir welding method according to claim 2, wherein
the buildup member is tilted so that its leading end is positioned frontward in a direction of movement of the buildup member than its opposite end while it is rotated and moved along said direction of movement.

7. The friction stir welding method according to claim 2, wherein
the friction stir welding is performed by the rotary tool to members having the buildup bead welded to at least the first member.

8. The friction stir welding method according to claim 2, wherein
while welding the buildup member to at least the first member, performing friction stir welding by the rotary tool following the buildup member at a rearward position along a relative direction of movement of the buildup member.

9. The friction stir welding method according to claim 2, wherein
the second member has a protruded block for placing the first member at a side of the butted portion;
the thickness from the protruded block to an upper surface of the second member is greater than the thickness of the first member;
an end of the second member is butted against the first member with the second member overlapped with the protruded block;
the buildup member is in contact with and rotated on the upper surface of the first member close to the second member to thereby weld the buildup bead; and
the rotary tool is inserted from the side having the buildup bead to perform friction stir welding of the second member and the first member.

10. The friction stir welding method according to claim 2, wherein
the panel thickness of the first member and the panel thickness of the second member at the butted portion are equal;
the first member and the second member are made of the same kind of metal; and
the buildup member is formed of the same kind of metal as the first and second members.

11. A friction stir welding method comprising:
welding a buildup bead using a buildup member to a surface side (side from which a friction rotary tool is inserted) of one of two members being overlapped with one another; and
thereafter, stack welding the two members using a friction rotary tool.

12. A friction stir welding method comprising:
welding a buildup bead to a surface side (side from which a friction rotary tool is inserted) of one of two members being overlapped with one another; and
stack welding the two members using a friction rotary tool.
